(19) United States
(12) Patent Application Publication
(10) Pub. No.: US 2010/0129120 A1
(43) Pub. Date: May 27, 2010

(54) Developing Device

(75) Inventors: Seiichi SENDA, Anjo-shi (JP); Keita SHIMIZU, Tsushima-shi (JP); Keisuke TAKAHASHI, Kasugai-shi (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: BROTHER KOGYO KABUSHIKI KAISHA, Nagoya (JP)

(21) Appl. No.: 12/621,661

(22) Filed: Nov. 19, 2009

(30) Foreign Application Priority Data
Nov. 25, 2008 (JP) 2008-299559

(51) Int. Cl. G03G 15/095

(52) U.S. Cl. 399/264

(57) ABSTRACT

A developing device comprises: a development roller configured to rotate while carrying liquid toner which comprises a carrier liquid and toner particles contained in the carrier liquid; a cleaning blade configured to contact with the development roller to scrape off the liquid toner carried on the development roller by the rotation of the development roller; and a cleaning roller provided adjacent to the development roller and upstream from the cleaning blade with respect to a rotating direction of the development roller. In the developing device, the development roller and the cleaning roller are configured to rotate in such a direction that outer peripheral surfaces thereof move in opposite directions to each other at a contact surface where the cleaning roller contacts with the development roller.

### CROSS-REFERENCE TO RELATED APPLICATION(S)

This application claims priority from Japanese Patent Application No. 2008-299559, which was filed on Nov. 25, 2008, the disclosure of which is incorporated herein by reference in its entirety.

### BACKGROUND OF THE INVENTION

1. Field of the Invention

The present invention relates to a developing device which comprises a development roller configured to carry liquid toner, and a cleaning blade configured to scrape off the liquid toner carried on the development roller.

2. Description of Related Art

A developing device comprising a development roller is known, in which liquid toner made by mixing toner particles in a carrier liquid is carried on the development roller. The development roller supplies an electrostatic latent image formed on a photoconductor drum with toner particles in the liquid toner, so that a toner image is formed on the photoconductor drum. In this developing device, if liquid toner is newly coated or applied on liquid toner remaining on the development roller after the development roller supplies the electrostatic latent image on the photoconductor drum with part of the toner particles in the liquid toner (i.e., after development), the thickness of the liquid toner layer on the development roller becomes nonuniform, which leads to deterioration in the obtained image quality. For this reason, it is necessary to scrape off the liquid toner remaining on the development roller after development.

For the purposes of improving the development efficiency from the development roller to the photoconductor drum as well as preventing toner particles from adhering to a non-latent image area, an operation for applying an electric field to the liquid toner layer on the development roller before development so that the toner particles coagulate on a surface of the development roller, which is so-called compaction, is generally carried out. However, because of this compaction, the carrier liquid is separated from the toner particles and the toner particles coagulate on the surface of the development roller, so that when the liquid toner after the development is scraped off by means of the cleaning blade, the separated carrier liquid flows across the surface of the cleaning blade and the aggregated toner particles remain at the edge of or on the surface of the cleaning blade. The size of the aggregated toner particles is thus increased, and disadvantageously the collection and reuse of the toner cannot be performed.

In order to overcome the above disadvantage, for example, Japanese Laid-open Patent Publication No. 2006-30719 discloses a developing device which comprises an electric field roller disposed apart from a development roller at a predetermined interval, and a cleaning blade provided downstream from the electric field roller with respect to a rotating direction of the development roller and configured to scrape off the liquid toner carried on the development roller by the rotation of the development roller. According to this developing device, an electric voltage is applied to the electric filed roller, and the electric field roller and the development roller rotate in the same direction; that is, the electric field roller and the development roller rotate in such a direction that their opposing surfaces move in the opposite directions to each other (i.e., against rotation). Therefore, aggregation of toner particles will be weakened.

However, even if the development roller and the electric field roller make an against rotation, in some cases, it may be insufficient to weaken the aggregation of toner particles on the surface of the development roller.

In view of the above, the present invention seeks to provide a developing device, which can disaggregate the toner particles carried on the development roller after compaction and development in a simple configuration and which can collect and reuse the liquid toner in a simple way.

### SUMMARY OF THE INVENTION

According to the present invention, a developing device comprises: a development roller configured to rotate while carrying liquid toner which comprises a carrier liquid and toner particles contained in the carrier liquid; a cleaning blade configured to contact with the development roller to scrape off the liquid toner carried on the development roller by the rotation of the development roller; and a cleaning roller provided adjacent to the development roller and upstream from the cleaning blade with respect to a rotating direction of the development roller. In this developing device, the development roller and the cleaning roller are configured to rotate in such a direction that outer peripheral surfaces thereof move in opposite directions to each other at a contact surface where the cleaning roller contacts with the development roller.

With this configuration of the present invention, the development roller and the cleaning roller are configured to contact with each other while allowing rotations of the development roller and the cleaning roller, and at their contact surface the development roller and the cleaning roller rotate in the opposite directions. This enables the cleaning roller to reliably scrape off the toner particles that have been carried on the development roller by means of compaction. Further, even if toner particles remaining on the development roller pass through between the cleaning roller and the development roller at the contact surface, toner particles which travel with the development roller by the rotation of the development roller and toner particles which travel with the cleaning roller by the rotation of the cleaning roller collide with each other, so that the toner particles carried on each roller are well dispersed into the carrier liquid.

The toner particles are dispersed in the carrier liquid, and this can prevent the toner particles from accumulating at the end face of the cleaning blade. Therefore, it is possible to collect and reuse the carrier liquid and the toner particles scraped off by the cleaning roller and the cleaning blade in a simple way. Further, since it is not necessary to apply an electric voltage to the cleaning roller, an aggregation of the toner particles carried on the development roller can be disaggregated in a simple configuration without requiring an electric voltage applying means.

According to the present invention, the toner particles are well dispersed in the carrier liquid by a simple configuration that the development roller and the cleaning roller are configured to rotate in such a direction that outer peripheral surfaces thereof move in opposite directions to each other at the contact surface where the cleaning roller contacts with the development roller. Therefore, it is possible to disaggregate the toner particles carried on the development roller after compaction and development in a simple configuration, and also to collect and reuse the liquid toner in a simple way.

### BRIEF DESCRIPTION OF THE DRAWINGS

To better understand the claimed invention, and to show how the same may be carried into effect, reference will now be made, by way of example only to the accompanying drawings, in which:

FIG. 1 is a schematic diagram of a laser printer; and

FIGS. 2A to 2C show the operation of a cleaning mechanism.

### DETAILED DESCRIPTION OF THE EXEMPLARY EMBODIMENT

A detailed description will be given of an exemplary embodiment of the present invention with reference to the drawings.

### Overall Configuration of Laser Printer

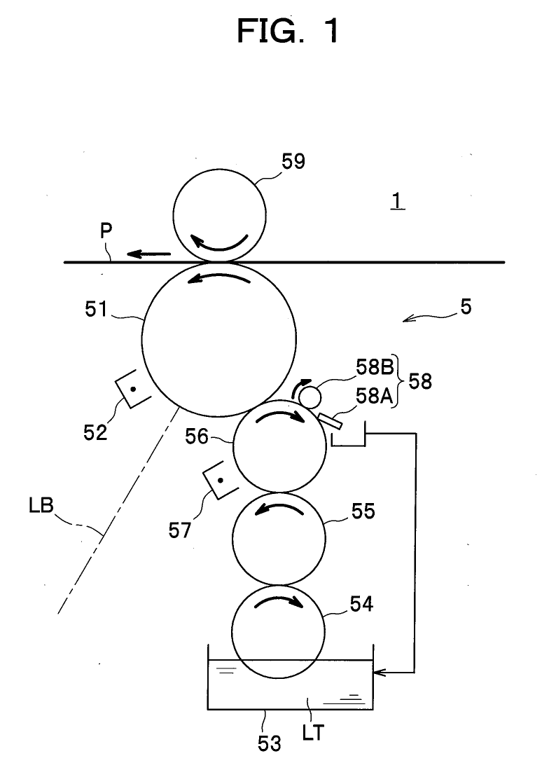

As seen in FIG. 1, a laser printer 1 mainly includes a process unit 5 configured to transfer a toner image onto a sheet P. Although not shown in the drawings, the laser printer 1 also includes other known equipment, such as a sheet feed unit configured to feed a sheet P to the process unit 5, an exposure device configured to expose a photoconductor drum 51 with light, and a fixing device configured to thermally fix a toner image that has been transferred onto a sheet P.

The process unit 5 mainly includes a photoconductor drum 51, a charger 52, a liquid toner reservoir 53, a supply roller 54, an intermediate roller 55, a development roller 56, a compaction charger 57, a cleaning mechanism 58, and a transfer roller 59. Details of the cleaning mechanism 58 will be described later, and other components will be described below.

The photoconductor drum 51 is a drum-shaped organic photoconductor, and an outer peripheral surface of the photoconductor drum 51 functions as an image carrying surface on which an electrostatic latent image is formed. The photoconductor drum 51 rotates in the counterclockwise direction of FIG. 1 when it is powered by a motor (not shown).

The charger 52 is disposed opposite to and apart from the photoconductor drum 51 at a predetermined interval. The charger 52 is configured to uniformly charge the surface (image carrying surface) of the photoconductor drum 51.

The liquid toner reservoir 53 is a reservoir for storing liquid toner LT. The liquid toner LT contains toner particles mixed in a nonvolatile carrier liquid. The liquid toner LT stored in the liquid toner reservoir 53 is supplied onto the development roller 56 via the supply roller 54, etc., and is collected from the development roller 56 by means of the cleaning mechanism 58. The collected liquid toner LT returns to the liquid toner reservoir 53 after readjustment of the concentration thereof.

The supply roller 54 rotates in the clockwise direction of FIG. 1 when it is powered by the motor (not shown). The supply roller 54 is configured such that the liquid toner LT stored in the liquid toner reservoir 53 is carried on the surface of the supply roller 54 and supplied onto the intermediate roller 55 by the rotation of the supply roller 54.

The intermediate roller 55 is a roller having recesses on an outer peripheral surface thereof so that a predetermined amount of the liquid toner LT is carried in the recesses. The intermediate roller 55 rotates in the counterclockwise direction of FIG. 1 when it is powered by the motor (not shown). Since the liquid toner LT is supplied onto the development roller 56 via the intermediate roller 55, the development roller 56 is always supplied with a constant amount of liquid toner LT.

The development roller 56 is a roller having an outer peripheral surface configured to carry the liquid toner LT. The development roller 56 rotates in the clockwise direction of FIG. 1 when it is powered by the motor (not shown). The development roller 56 contacts with the photoconductor drum 51 so that toner particles contained in the liquid toner LT that is carried on the development roller 56 are supplied onto an electrostatic latent image formed on the photoconductor drum 51, to thereby form a toner image on the photoconductor drum 51. The development roller 56 is made of a material (e.g., urethane rubber) softer than that of a cleaning roller 58B to be described later.

The compaction charger 57 is configured to apply an electric field to the liquid toner LT carried on the development roller 56 so that the toner particles in the carrier liquid are pressed against (aggregated at) the surface of the development roller 56.

The transfer roller 59 is a roller arranged opposite to the photoconductor drum 51 so as to nip therebetween a sheet P conveyed from the sheet feed unit. A toner image formed on the photoconductor drum 51 is transferred onto the sheet P when the sheet P passes through between the transfer roller 59 and the photoconductor drum 51.

In the process unit 5 configured as described above, the surface of the photoconductor drum 51 is uniformly charged by the charger 52, and is exposed to a laser beam LB emitted from the exposure device. Therefore, the electric potential of the exposed areas lowers, so that an electrostatic latent image associated with an image data is formed on the surface of the photoconductor drum 51. In the meantime, the liquid toner LT stored in the liquid toner reservoir 53 is supplied onto the development roller 56 via the supply roller 54 and the intermediate roller 55.

Thereafter, toner particles contained in the liquid toner LT carried on the development roller 56 are supplied onto the electrostatic latent image formed on the photoconductor drum 51, so that a toner image corresponding to the electrostatic latent image is formed on the photoconductor drum 51. The toner image formed on the photoconductor drum 51 is then transferred onto the sheet P when the sheet P conveyed from the sheet feed unit is nipped and passes through between the photoconductor drum 51 and the transfer roller 59.

### Configuration of Cleaning Mechanism

Next, the configuration of the cleaning mechanism 58 will be described in detail.

As seen in FIG. 1, the cleaning mechanism 58 includes a cleaning blade 58A and a cleaning roller 58B.

The cleaning blade 58A contacts with the development roller 56 to scrape off the liquid toner LT carried on the development roller 56 by the rotation of the development roller 56. To be more specific, the cleaning blade 58A is positioned adjacent to the development roller 56 and downstream from a contact surface between the development roller 56 and the photoconductor drum 51 with respect to the rotating direction of the development roller 56, so that the liquid toner LT remaining on the development roller 56 can be scraped off after a part of, the toner particles is supplied from the development roller 56 onto the photoconductor drum 51 (i.e., after development).

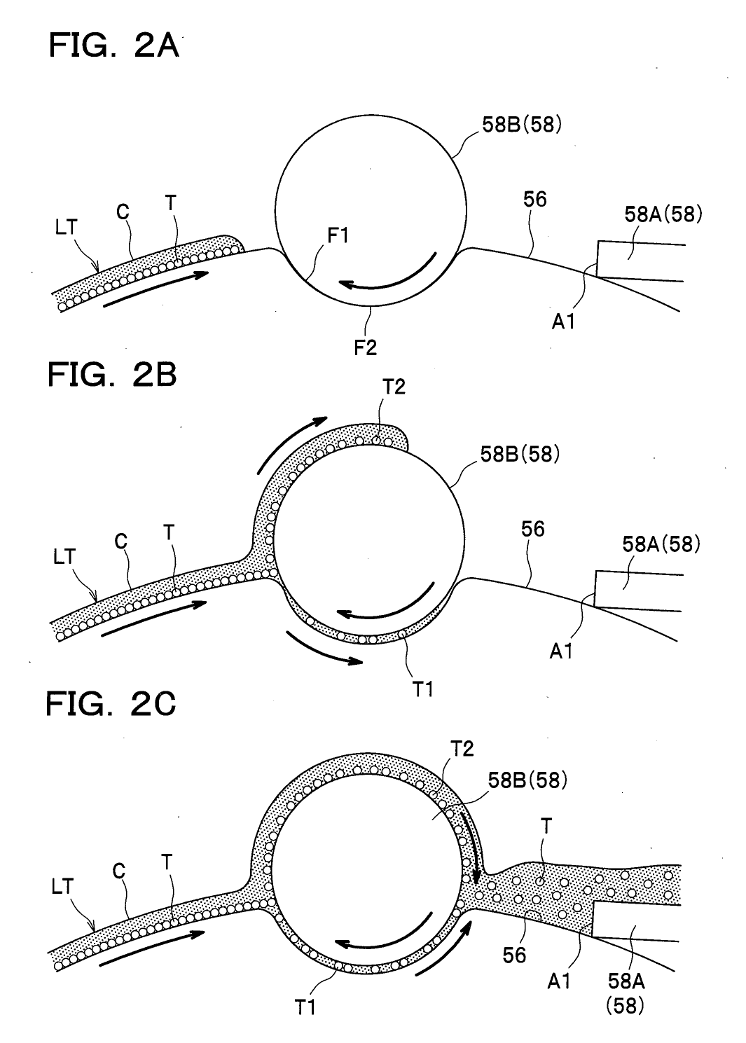

The cleaning roller 58B is a metal roller. The cleaning roller 58B is positioned to contact with the development roller 56 while allowing rotation of the development roller 56. The cleaning roller 58B is positioned upstream from the cleaning blade 58A with respect to the rotating direction of the development roller 56. To be more specific, the cleaning roller 58B is pressed against the development roller 56 made of a material softer than that of the cleaning roller 58B in such a manner as to cause the outer peripheral surface of the development roller 56 to deform inward (see FIG. 2A). In this condition, the cleaning roller 58B rotates in the same direction as the development roller 56 does (i.e., clockwise direction of FIG. 2A) when it is powered by the motor (not shown). In other words, the development roller 56 and the cleaning roller 58B rotate in such a direction that their opposing surfaces F1, F2 (see FIG. 2A) move in the opposite directions to each other at the contact surface where the cleaning roller 58B contact with the development roller 56.

### Operation of Cleaning Mechanism

Next, the operation of the cleaning mechanism 58 will be described in detail with reference to FIGS. 2A to 2C. For the purpose of explanation, the amount of an inward deformation of the development roller 56 caused by the cleaning roller 58B and the size of toner particles are shown in an exaggerated manner.

As seen in FIGS. 2A and 2B, the liquid toner LT remaining on the development roller 56 after development first collides with the cleaning roller 58B. At this time, since the opposing surfaces F1, F2 of the cleaning roller 58B and the development roller 56 move in the opposite directions at their contact surface while strongly and frictionally contacting with each other, the toner particles T adhering to the surface of the development roller 56 after compaction are scraped off by the cleaning roller 58B in a reliable manner.

Further, if the toner particles T carried on the development roller 56 pass through between the cleaning roller 58B and the development roller 56, as seen in FIG. 2C, toner particles T1 which travel with the development roller 56 by the rotation of the development roller 56 and toner particles T2 which travel with the cleaning roller 58B by the rotation of the cleaning roller 58B collide with each other. Therefore, the toner particles T carried on each roller 56, 58B are well dispersed in the carrier liquid C.

Accordingly, the toner particles T are dispersed in the carrier liquid C, and this can prevent the toner particles T from accumulating at an end face Al of the cleaning blade 58A.

According to the present embodiment as described above, the following advantageous effects can be expected.

The toner particles T are well dispersed in the carrier liquid C by a simple configuration that the development roller 56 and the cleaning roller 58B to which an electric voltage is not applied are configured to rotate in such a direction that their opposing surfaces F1, F2 move in the opposite directions to each other at the contact surface where the cleaning roller 58B contacts with the development roller 56. Therefore, it is possible to disaggregate the toner particles T carried on the development roller 56 after compaction and development in a simple configuration, and also to collect and reuse the liquid toner LT in a simple way.

The development roller 56 is made of a material softer than that of the cleaning roller 58B, and the cleaning roller 58B is positioned to cause the outer peripheral surface of the development roller 56 to deform inward. This makes it possible to reduce the amount of toner particles T passing through between the development roller 56 and the cleaning roller 58B. As a result, an accumulation of the toner particles T at the end face A1 of the cleaning blade 58A can be prevented in a more reliable manner.

Since the cleaning roller 58B is made of metal, the surface of the cleaning roller 58B can be made smooth. Therefore, when the development roller 56 and the cleaning roller 58B rotate in such a manner that their opposing surfaces F1, F2 move in the opposite directions at their contact surface while strongly contacting with each other, the development roller 56 is less susceptible to damage on the surface thereof.

Although the present invention has been described in detail with reference to the above embodiment and the accompanying drawings, the present invention is not limited to this specific embodiment and various changes and modifications may be made without departing from the scope of the appended claims.

In the above-described embodiment, the cleaning roller 58B is positioned to cause the outer peripheral surface of the development roller 56 to deform inward. However, the present invention is not limited to this specific embodiment. For example, the cleaning roller may be positioned to slightly contact with the development roller.

In the above-described embodiment, the whole process unit 5 is defined as the developing device. However, the present invention is not limited to this specific embodiment. For example, in the case where the process unit 5 is divided into one or more drum cartridges each having a photoconductor drum 51, etc., and one or more developer cartridges each having a development roller 56, the developing device according to the present invention may be adopted for the developer cartridge. Further, in the case where the developer cartridge is divided into a development unit mainly comprising the development roller 56 and a toner cartridge having the liquid toner reservoir 53, the developing device according to the present invention may be adopted for the development unit.

In the above-described embodiment, the present invention has been applied to the laser printer 1. However, the present invention is applicable to other image forming apparatuses, such as a copying machine and a multifunction device. Further, the kinds of the carrier liquid and the toner particles of the liquid toner, etc. may be set arbitrarily where appropriate.

### Example

A working example of the above-described embodiment will be described below. To be more specific, the following experimental result shows advantageous effects achieved by the cleaning mechanism.

Various conditions for this experiment are as follows:

| | | |
|---|---|---|
| (1) Liquid toner | | |
| Carrier: | paraffin oil | |
| Toner particles: | epoxy resin | |
| Concentration of toner: | 30% (weight | |
| | concentration) | |
| Viscosity: | 200 mPa · s | |
| (2) Development roller: | | |
| Urethane rubber | φ22 mm | Circumferential speed: |
| | | 160 mm/s |
| (3) Cleaning roller: | | |
| SUS | φ8 mm | Circumferential speed: |
| | | 160 mm/s |

(Cleaning roller and Development roller rotate in the opposite directions
at their contact surface.)

| | |
|---|---|
| (4) Amount of inward | 200 μm |
| deformation: | |
| (5) Thickness of toner layer on | approx. 5 μm |
| the development roller: | |
| (6) Applied voltage of corotron | approx. 3 kV |
| wire (compaction charger) | |
| (7) Thickness of cleaning blade | 3 mm |
| (height from the surface of the | |
| development roller) | |

An experiment was carried out under the above experimental conditions to visually check whether or not toner particles accumulate at the end face of the cleaning blade. The experiment showed that the liquid toner scraped off by the cleaning blade was smoothly collected without accumulating at the end face of the cleaning blade.

What is claimed is:

1. A developing device comprising:
a development roller configured to rotate while carrying liquid toner which comprises a carrier liquid and toner particles contained in the carrier liquid;
a cleaning blade configured to contact with the development roller to scrape off the liquid toner carried on the development roller by the rotation of the development roller; and
a cleaning roller provided adjacent to the development roller and upstream from the cleaning blade with respect to a rotating direction of the development roller,
wherein the development roller and the cleaning roller are configured to rotate in such a direction that outer peripheral surfaces thereof move in opposite directions to each other at a contact surface where the cleaning roller contacts with the development roller.

2. A developing device according to claim 1, wherein the development roller is made of a material softer than that of the cleaning roller, and the cleaning roller is positioned to cause the outer peripheral surface of the development roller to deform inward.

3. A developing device according to claim 2, wherein the development roller is made of urethane rubber and the cleaning roller is made of metal.

4. A developing device according to claim 1, wherein an electric field is applied to the liquid toner carried on the development roller so that the toner particles in the carrier liquid are aggregated on the outer peripheral surface of the development roller.
